(19) United States
(12) Patent Application Publication
(10) Pub. No.: US 2008/0067850 A1
(43) Pub. Date: Mar. 20, 2008

(54) Backrest for a chair

(75) Inventors: Rune Stenstrom, Sundsvall (SE); Goran Udden, Haninge (SE)

Correspondence Address: HOLLAND & HART, LLP, P.O BOX 8749, DENVER, CO, 80201, US

(73) Assignee: Permobil AB, TIMRA (SE)

(21) Appl. No.: 11/901,781

(22) Filed: Sep. 19, 2007

(30) Foreign Application Priority Data
Sep. 19, 2006 (SE) 0601940-0
Sep. 19, 2006 (SE) 0601939-2

(51) Int. Cl. B60N 2/02

(52) U.S. Cl. 297/353

(57) ABSTRACT

Backrest (2) for a chair, for example a wheelchair, a vehicle chair, a office chair or the like, which backrest has a lower (2a′) and an upper end (2b′), and a general longitudinal direction which extends between the lower and the upper end. The backrest comprises an upper part (2b) which is rotable in relation to a lower part (2a) of the backrest, about a rotational axis, which is essentially parallel with the longitudinal direction.

### FIELD OF THE INVENTION

The invention relates to a backrest for a chair, and is particularly a wheelchair, which backrest has a lower and an upper end, and a general longitudinal direction which extends between the lower and the upper end. The invention also relates to a chair and in particular, a wheelchair, comprising such a backrest. The backrest according to the invention may be used at a number of different types of chairs, such as vehicle chairs, office chairs and other working chairs. The backrest is especially suitable to be used at wheelchairs for disabled persons.

### BACKGROUND AND PRIOR ART

For example modern wheelchairs often allow a number of different settings of the wheelchair seat. The seat may comprise a normally horizontal part, on which the user's bottom rests, a backrest, two arms rests and two leg supports. Modern advanced wheelchairs can, for example, allow separate adjustment of the height and inclination of the whole seat in relation to the chassis, the inclination of the leg supports in relation to the normally horizontal part, and the inclination of the arm rests in relation to the backrest.

The configuration of the backrest is of special importance for producing an ergonomic and comfortable wheelchair. The backrest should, inter alia, give a correctly harmonized support to separate parts of the user's upper body. At the same time, the backrest should be comfortable, secure, take up little space and allow good freedom of movement. The user's physical constitution, mobility and need for mechanical support vary within very wide limits. It is therefore desirable for the wheelchair to be individually adapted to each user. In order as far as possible to meet this requirement, it is known to provide different seats or backrests which are configured to fit certain groups of users, for example with regard to the height and mobility of the user. It is also known to provide certain separate accessories such as lumbar supports, which, when used together with the backrest, offer a further harmonization to the needs of the user.

U.S. Pat. No. 6,352,307 B1 further describes a seat frame having a backrest part for a wheelchair. The width of the seat frame is adjustable to allow the seat with the backrest to be adapted to different users.

### BRIEF DESCRIPTION OF THE INVENTION

One object of the invention is to provide an improved backrest for a chair and in particular, a wheelchair. Another object is to provide an ergonomically and anatomically advantageous backrest which at the same as it provides an adequate support to the user also allows for favourable freedom of movement. Another object of the invention is to provide an ergonomically and anatomically advantageous backrest which allows individuals adaptation of the backrest to different users.

These and other objects are obtained with a backrest of the kind defined in the introduction to this description, which backrest has the features specified in the claims.

The backrest has a lower and an upper end, and a general longitudinal direction which extends between the lower and the upper end. At least one pair of width-adjusting members is fixed in a laterally displaceable manner to a central backrest framework extending in the longitudinal direction of the backrest. An extension member is displaceably fixed to at least one of the width-adjusting members, to allow adjustment of the width of the backrest. With the width-adjusting members and the extension member according to the invention, it is possible to adapt the width of the backrest to users who have different physical constitution and who have their own separate needs with regard to support for the back.

The backrest may comprise a number of pairs of width-adjusting members disposed one after the other in the longitudinal direction and fixed to the backrest framework. This yields the fundamental advantage that the width of the backrest can be varied in the longitudinal direction of the backrest. The pairs of width-adjusting members may comprise a first and a second width-adjusting plate, which are displaceable in the direction towards and away from each other along a common displacement axis. Such plates give good support to the back, even for heavy individuals.

The extension member is may be formed of an elastic material and comprise an inner and an outer section, which outer section is more rigid than the inner section. In this way, displacement of the extension member along an angled or curved width-adjusting plate is enabled, while, at the same time, a part of the extension member which projects from the plate gives satisfactory support to the user.

The backrest may comprise a number of elements arranged one after the other in the longitudinal direction, which elements form the backrest framework. A pair of width-adjusting members may, in this case, be displaceably fixed to one, some or all of the elements.

The width-adjusting plates may comprise a first section and a second section, which second section extends in the direction diagonally outwards and forwards from the first section. As a result, the backrest, apart from giving support in the rearward direction, can also give an ergonomic and well adapted support in the lateral direction. Said elements may be detachably fixed to one another to allow construction of backrests with variable length. In order to allow further scope for ergonomic and anatomical adaptation, at least one of the elements can be rotatable about a transverse rotational axis.

The invention also relates to a chair comprising such a backrest. The backrest is intended for a chair, for example a wheelchair, a vehicle chair, an office chair or the like. The backrest has a lower and an upper end, and a general longitudinal direction which extends between the lower and the upper end. An upper part of the backrest is rotable about a rotational axis, which rotational axis is essentially parallel with the longitudinal direction of the backrest, in relation to a lower part of the backrest. The lower part is prevented from rotation about said rotational axis. Hereby a considerably increased movability is provided for a user situated on the chair, for example when the user is turning backwards in order to reach an object which is placed diagonally backwards from the chair. At the same time the backrest provides full support to the entire length of the user's back, both when the user is facing forwards and when he or she is turning. Since the lower part of the backrest is prevented from rotation about the axis which is parallel with the longitudinal axis of the backrest, this part gives extra support to the lower portion of the user's back also at such torsional movement of the back. Such an extra support of the lower portion of the back is of great importance especially for disabled persons.

The upper part of the backrest may be separable from the lower part, in order to allow use of the chair with only the lower backrest part. Such an embodiment also facilitates transport of the chair, since the height of the chair readily may be reduced by removing the upper part.

The backrest suitably comprises a spring-back device, which is designed to resiliently return the upper part to a normal position when the upper part has been rotated, in relation to the lower part, to a rotary position which is different from the normal position. Hereby, for instance the ergonomics of the chair is improved since the back and trunk musculature of the user is relieved during the return movement. This entails a considerable advantage, especially for disabled users. Also for not disabled users, such an embodiment reduces the risk of musculo-skeletal injuries, for example if the back rest is arranged at a work chair.

In order to further enhance the ergonomics and to allow individual adaptation of the wheelchair to different users, the spring-back device preferably comprises a control device by which the biasing force by which the spring back device strives to return the upper part to the normal position may be adjusted.

The lower part suitably comprises a base element and the upper part a number of build-on elements which are releasably attachable to each other in order to allow construction of a backrest having variable length. By this means backrests having different height may be produced easily at comparatively low cost. This embodiment also allows for that the backrest readily may be individually adapted to different users.

In order to further allow for individual adaptation of the backrest and for achieving an ergonomic and well adapted support for the user, the backrest may comprise at least one and preferably at least one pair of width-adjusting members which is fixed, transversely displaceable to at least one of the base element or the built-on elements, for allowing adjustment of the width of the backrest.

The invention also relates to a chair comprising a backrest.

Further objects and advantages of the invention emerge from the detailed description of illustrative embodiments below, and from the following patent claims.

### BRIEF DESCRIPTION OF THE FIGURES

Illustrative embodiments of the invention will be described below with reference to the figures, whereof:

FIGS. 1a and 1b are side views of a wheelchair seat having a backrest according to the invention, in which FIG. 1b shows a component on an enlarged scale of the seat shown in FIG. 1a,

FIGS. 2a and 2b are exploded diagrams, shown diagonally from the front, of the backrest shown in FIG. 1a, with certain components removed,

FIG. 3 is an exploded diagram, shown diagonally from the rear, of an upper part of the backrest shown in FIG. 1a,

FIGS. 4a and 4b are respectively a side view and a perspective view diagonally from the rear, which show in a mounted position certain of the components shown in FIG. 3,

FIG. 5 is a side view of the backrest shown in FIGS. 2a and 2b, in which an upper part has been separated from a lower part,

FIGS. 6a and 6b are respectively a perspective view diagonally from above and a plan view from above, which show a part of the backrest shown in FIG. 1 in a rotation position.

### DETAILED DESCRIPTION OF EMBODIMENTS

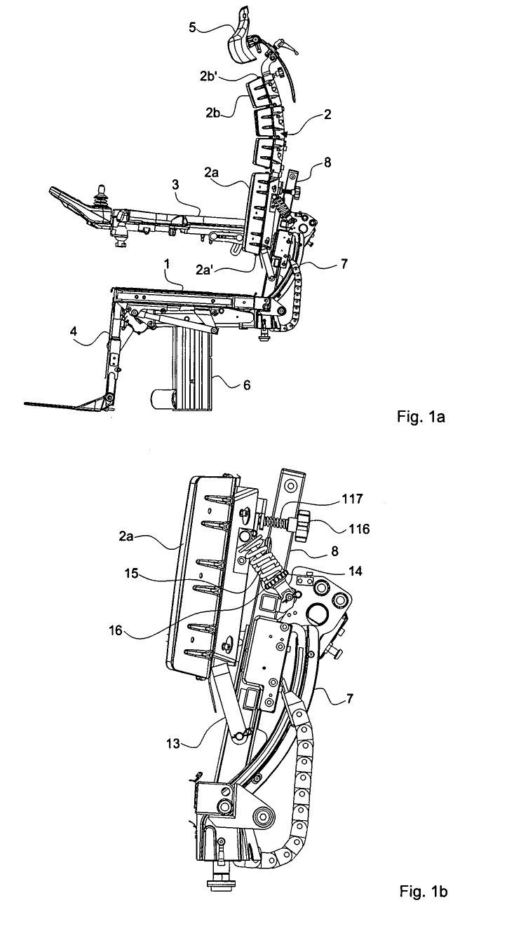

In FIG. 1a a wheelchair seat is shown, comprising a seat part 1, which is intended to support a user's bottom, a backrest 2, two arm rests, of which only the right-hand one 3 is shown, a leg support 4 and a neck rest 5. The seat is fitted to a seat lift 6, which is fitted to a wheelchair chassis (not shown) to allow raising and lowering of the wheelchair seat in relation to the chassis.

The backrest 2 comprises a lower part 2a and an upper part 2b. The backrest also has a lower end 2a′ and an upper end 2b′. The general longitudinal direction of the backrest extends between the lower 2a′ and the upper end 2b′. It will be appreciated that the terms lower and upper are merely used for increased clarity and that the end 2b′ does not necessarily have to be above the end 2a′, for example if the backrest is tilted rearwards into a horizontal position. Correspondingly, the term transverse is here used to define a direction which extends between to the two sides of the wheelchair seat and which is perpendicular to the forward rearward direction of the seat.

As can most clearly be seen from FIG. 1b, the wheelchair seat comprises a tilt device 7, which, inter alia, allows inclination of the backrest by rotation about a transverse axis in relation to the backrest. For this purpose, the lower part 2a of the backrest is fixed to a backrest frame 8 which is articulately connected to the tilt device 7.

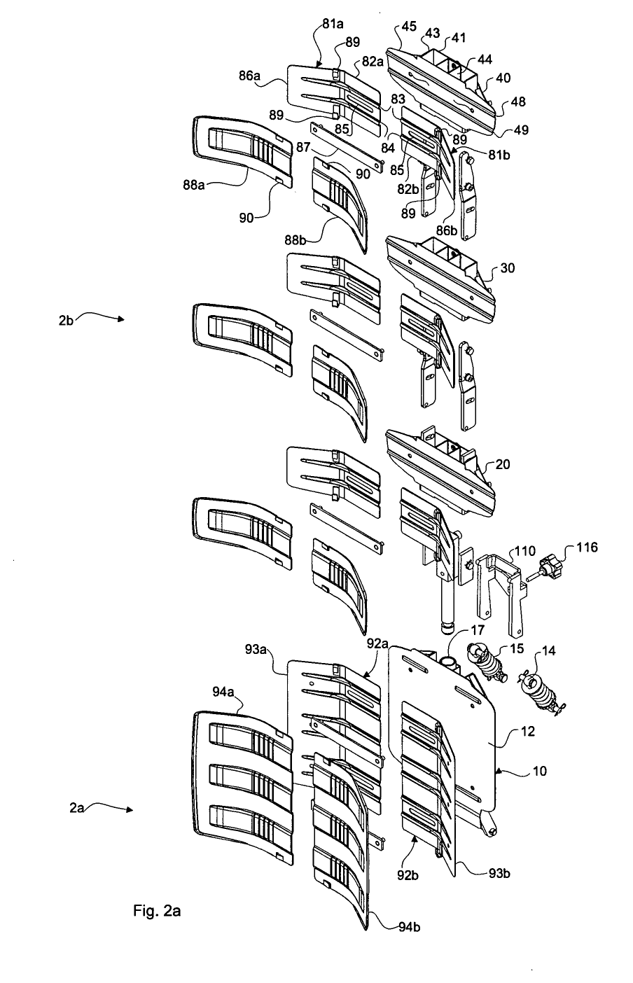

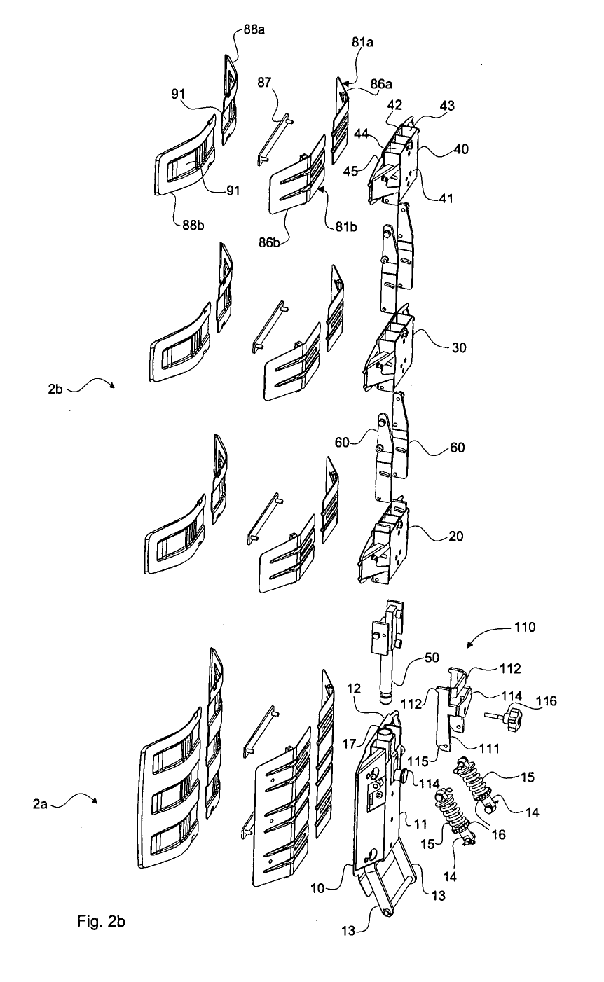

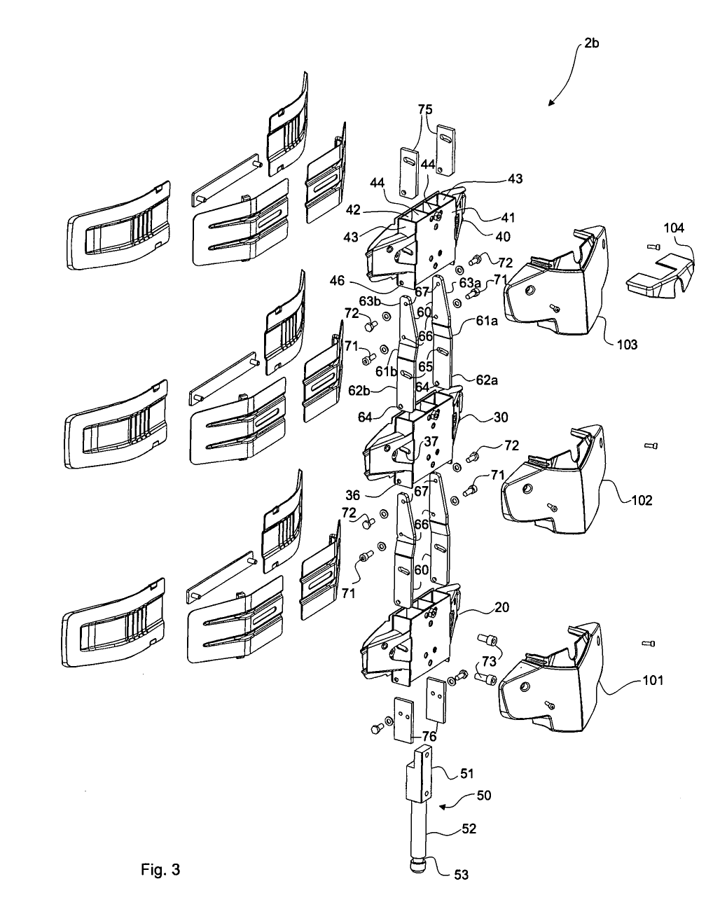

As can most clearly be seen from FIGS. 2a, 2b and 3, the backrest 2 is constructed from a modular system comprising a number of modular elements. In the example shown, the backrest 2 comprises a base element 10 and three built-on elements 20, 30, 40, which together with below-described coupling members may form a backrest framework. The built-on elements 20, 30, 40 are mutually identical and are formed of a relatively rigid material. In the example shown, the built-on elements and the base element are made of steel, but other materials, such as, for example, aluminium and certain rigid plastic materials, can also possibly be used. The built-on elements 20, 30, 40 comprise a box-shaped part having a rear 41 and a front 42 plate, and outer 43 and inner 44 plates extending between these. A slide plate 45 projecting laterally from the box-shaped part is fixed to the front plate 42. Each built-on element 20, 30, 40 is covered by a rear cap 101, 102, 103. An end cap 104 is fitted to the uppermost built-on element 40.

The base element 10 has a greater height in the longitudinal direction of the backrest than each of the built-on elements 20, 30, 40. The base element comprises a hollow part 11, to the front side of which there is fixed a slide plate 12. A tube 17 having a circular-cylindrical inner shell surface is centrally accommodated in and fixed to the hollow part 11. The axis of the tube 17 extends substantially parallel to the longitudinal direction of the backrest. At its lower end, the base element has two diagonally downward projecting arms 13, by means of which the base element 10 is rotatably fixed to the backrest frame 8 about a horizontal transverse axis (see FIG. 1b). The backrest can thereby be rotated or pivoted about a transverse rotational axis in relation to the backrest frame 8 and the seat part 1. The base member 10 is however prevented from rotation or pivotal movement about an axis which is parallel with the longitudinal direction of the backrest. By this means the lower portion of a user's back is always fully supported by the base member, even when the user turns his or her upper back portion for example for reaching an object which is placed diagonally behind the wheelchair.

Two telescopic arms 14, at their one ends, are articulately fixed to the base element 11 and, at their other ends, are articulately fixed to the backrest frame 8. A compression spring 15 is arranged around each telescopic arm 14 and presses the ends of the arms 14 in a direction away from each other. The compressive force of the compression springs 15 can be regulated with the aid of a rotatable adjusting nut 16, which is accommodated in threaded arrangement on each telescopic arm and against which the respective compression spring rests. The backrest is thereby resiliently rotatable about a transverse rotational axis in relation to the seat part, which helps to produce an ergonomically and anatomically advantageous wheelchair seat. The resilient rotatability of the backrest also provides a shock-absorbing function, which reduces the risk of injury to the user and increases the comfort.

The lower built-on element 20 is connected to the base element 10 by means of a first coupling member 50. The first coupling member 50 comprises an upper part 51 of square cross section, which is accommodated between the inner plates of the lower built-on element 20 and is fixed to this by means of screws extending through screw holes in the rear plate of the lower built-on element 20. The coupling member 50 also comprises a downward projecting cylindrical pin 52, which close to its free end has a circumferentially recessed groove 53 and a bevel arranged at the end.

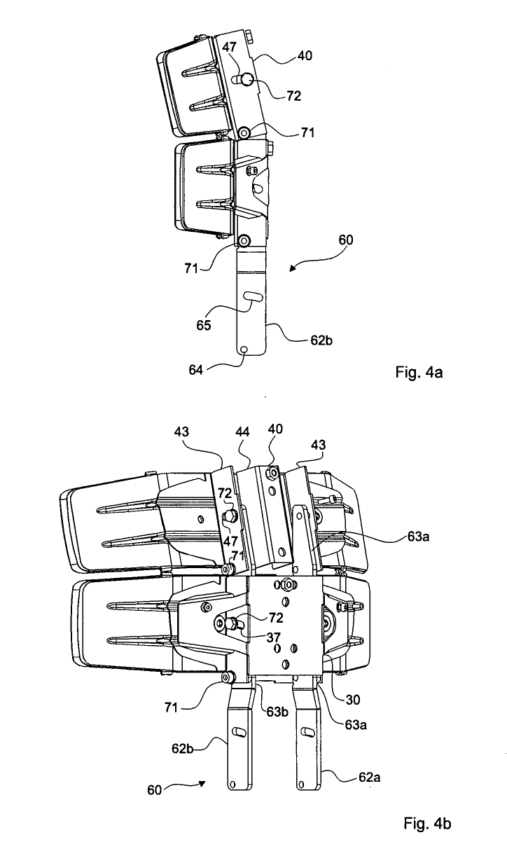

For detachable fixing of two successive built-on elements 20, 30, 40, the modular system also comprises second coupling members 60. As can most clearly be seen from FIGS. 3, 4a and 4b, each of the second coupling members 60 comprises a first 61a and a second 61b link arm, which link arms are arranged side by side in the lateral direction. The link arms 61a, 61b are formed of bent flat irons and have a lower section 62a, 62b and an upper section 63a, 63b each. The lower sections 62a, 62b are arranged at a greater distance apart than the upper sections 63a, 63b. The difference in spacing between these sections corresponds to double the material thickness of the flat irons. The upper sections of two lower link arms can hence be received between the lower sections of two upper link arms.

The lower sections 62a, 62b have similar widths and are received in guided arrangement between the rear and front plate of a lower built-on element 30. The upper sections 63a, 63b are upwardly tapered and are accommodated between the rear 41 and the front 42 plate of an upper built-on element 40. The upper built-on element 40 is thereby allowed to be rotated about a transverse rotational axis in relation to the two link arms 61a, 61b and to the lower built-on element 30. The upper built-on element 40 is rotatably fixed to the link arms 61a, 61b by means of first screws 71, which are accommodated in screw holes 46 in the outer plates 43 of the upper built-on element and in threaded screw holes 66 in the link arms. The first screws 71 define the transverse rotational axis about which the upper built-on element 40 is rotatable. Second screws 72 extend through arched slots 47 in the outer plates 43 of the upper element 40 and are accommodated in threaded arrangement in screw holes 67 in the link arms. The lower sections 62a, 62b of the link arms are fixed to the lower built-on element 30 by means of corresponding first 71 and second 72 screws, which extend through screw holes 36 and slots 37 in the lower built-on element 30, as well as through screw holes 64 and arched slots 65 in the lower sections 62a, 62b of the link arms and through the screw holes 66, 67 of below-placed link arms. The arched slots 65 allow the built-on element 30 correspondingly to be rotated about a transverse axis in relation to a further built-on element 20 disposed below the element 30. The uppermost 40 and lowermost 20 built-on elements in the backrest receive distance and screw plates 75, 76 respectively, which compensate for the fact that these built-on elements do not receive any lower or upper section of link arms.

With the above-described construction, it is therefore possible to individually adjust the angle of inclination of each built-on element 30, 40 disposed above the lowermost built-on element 20. The angle of inclination can be adjusted within a range which is defined by the length of the arched slots 37, 65, 47. Once the desired angle of inclination of a built-on element is set, this angle is fixed by tightening of the screws 72. It will be appreciated that the angle of inclination for each installable built-on element 30, 40 can only be changed or adjusted by first loosening the screws 72, adjusting the angle by rotation about the screws 71 and subsequently retightening the screws 72.

With the above-described modular system, it is also possible to individually adapt the length of the backrest by choosing a desired number of built-on elements. It will be appreciated that the length of a mounted backrest can also afterwards be adapted by the fitting of additional built-on elements or the removal of existing built-on elements.

The modular system can also comprise third coupling members (not shown) for fixing a built-on element to the base element. These third coupling members are configured to allow rotation about a transverse rotational axis of the built-on element in relation to the base element. This makes it possible for the angle of inclination of the lowermost built-on element, also, to be adjusted in relation to the base element.

For individual adaptation of the width of the backrest, the backrest comprises width-adjusting members. With reference firstly to FIGS. 2a and 2b, the slide plates 45 of each built-on element 40, 30, 20 have upper 48 and lower 49 forward projecting transverse guide grooves. A first 81a and a second 81b relatively rigid width-adjusting plate are fixed to the slide plate 45. Each width-adjusting plate has a central section 82a, 82b, which bears against the slide plate 45. The central sections have transverse deformations 83, 84. The deformations 83, 84 form indents on the rear side of the central sections and bulges on its front side. The guide grooves 48, 49 of the slide plate 45 are accommodated in the indents of the deformations 83, 84. The central sections 82a, 82b also have continuous elongated slots 85, which extend parallel with the deformations 83, 84. The two width-adjusting plates 81a, 81b comprise further side sections 86a, 86b, which extend diagonally forwards and in the lateral direction outwards from the outer ends of the central sections 82a, 82b. The width-adjusting plates 81a, 81b are fixed to the slide plate 45 by means of an elongated clamping plate 87. The clamping plate is pressed in the direction of the slide plate by means of screw nut joints (not shown), which extend through the slots 85 and through continuous holes 45a made in the slide plate 45. By first undoing the screw nut joints, it is possible to displace the width-adjusting plates 81a, 81b in the lateral direction and subsequently fix the width-adjusting plates in the desired position by tightening of the screw nut joints.

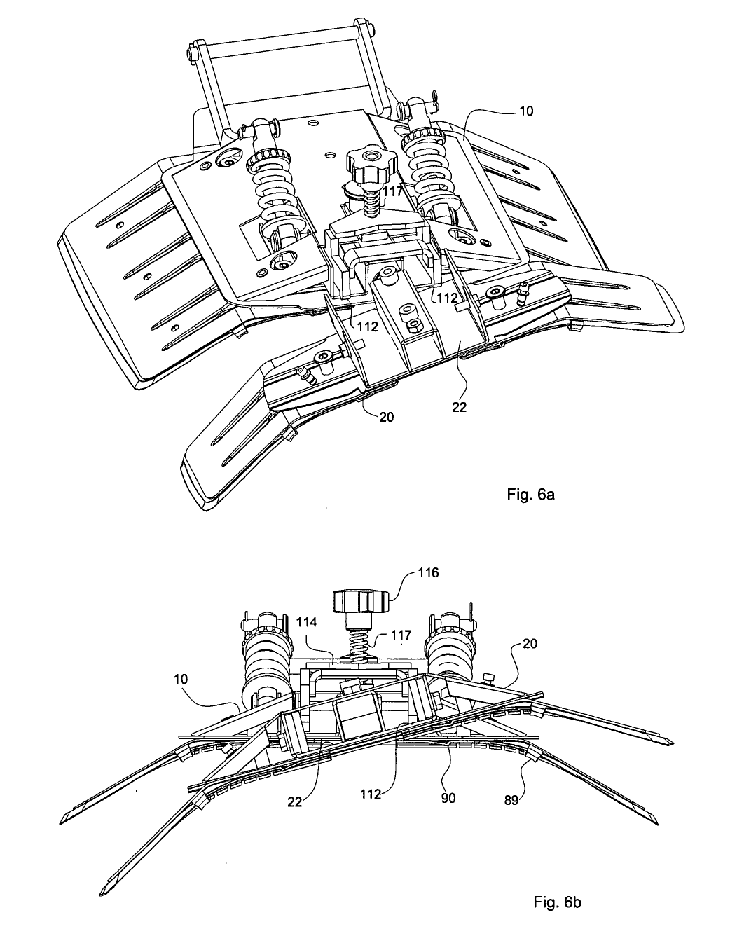

The backrest also comprises wing-shaped members 88a, 88b, which are made of an elastic material such as a plastics material, and which may constitute extension members. An elastic member is fitted to each width-adjusting plate. For this purpose, the width-adjusting plates 81a, 81b have first hooks 89, which hook around the elastic members. Each elastic member 88a, 88b has a transverse deformation 91, which forms an indent on the rear side, facing the respective width-adjusting plate, of the member. The forward bulging deformations 83, 84 of the width-adjusting plates are received in guiding arrangement in the deformations 91 of the elastic members so as to allow guided lateral displacement of the elastic members in relation to the respective width-adjusting plate. The elastic members 88a, 88b are thus telescopically displaceable along the width-adjusting plates 81a, 81b. The elastic members 88a, 88b further have wedge-shaped stops 90 (see also FIG. 6b), which allow the elastic members to be slid in towards the centre, the stops 90 being able to pass the hooks 89. When the elastic members are extended, the stops 90 define a maximally extended position through blocking contact against the hooks 90.

The elastic members 88a, 88b are, in their natural position, substantially rectilinear. In the figures, the elastic members are shown in the bent state which they assumed when they were fitted on and, by means of the hooks 89, were fixed to the width-adjusting plates. The elasticity of the elastic members endeavours to straighten out the members, which helps to detain the elastic members on the width-adjusting plates. If so desired, the elastic members can additionally be fixed to the width-adjusting plates, for example, by means of Velcro tape fastenings, which are fitted between the elastic members and the width-adjusting plates.

The outer ends of the elastic members 88a, 88b are more rigid than the inner sections. This allows the weaker sections to be displaced passed the bent connection between the central sections 82a and side sections 86a of the width-adjusting plates 81a, 81b, while, at the same time, the outer sections of the elastic members, even in the extended position, give satisfactory support to the user's back.

As can clearly be seen from the figures, corresponding width-adjusting plates 92a, 92b having side sections 93a, 93b and elastic members 94a, 94b are also fitted to the lower base element 10 of the backrest.

With the above-described width-adjusting plates 81a, 81b, 92a, 92b and elastic members 88a, 88b, 93a, 93b, it is possible to individually adjust the width of the backrest telescopically for each user. Since each width-adjusting plate and elastic member can be separately adjusted, it is possible to vary the width of the backrest along the longitudinal direction of the backrest. It is also possible to achieve asymmetrical adjustment of the width-adjusting plates 88a, 88b, 93a, 93b having the laterally supporting side sections 86a, 86b, 94a, 94b, which can be a considerable advantage, especially for users having certain types of disabilities or other handicaps.

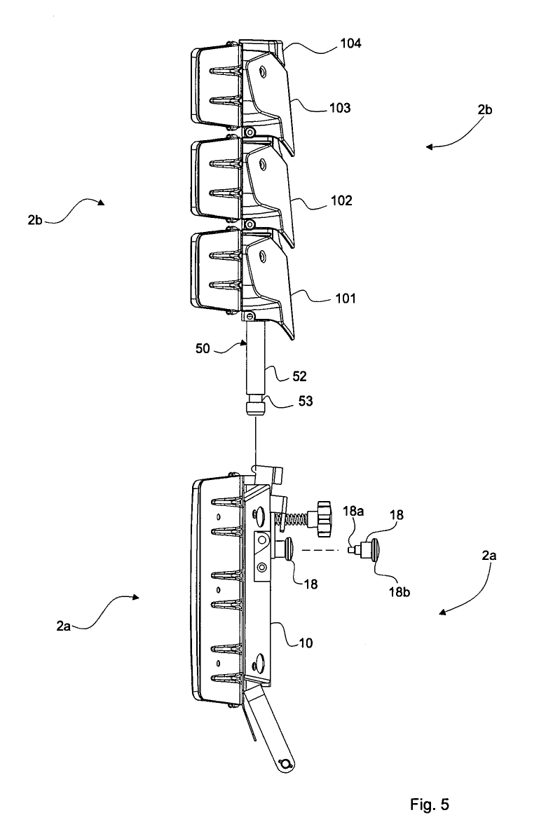

As can most clearly be seen from FIG. 5, the upper part 2b of the backrest is separable from the lower part 2a. The upper part 2b is constituted by that part of the backrest which is made of up a number of built-on elements 20, 30, 40. In the example shown in the figures, the upper part comprises three built-on elements 20, 30, 40, which, in FIG. 5, are covered by the caps 101, 102 and 103 respectively. The lower part 2a of the backrest is constituted by the part comprising the base element 10.

The upper part 2b is connectable to the lower part 2a by means of the first coupling member 50. When the upper part 2b is to be mounted on the lower part 2a, the downward projecting pin 52 of the first coupling member is introduced into the tube 17 (see FIG. 2b). The axial position of the pin 52 in the tube 17 is fixed by means of a fixing member 18, which is disposed on the base element 10 and which has an engagement pin 18a. In FIG. 5, the fixing member 18 is shown both separate and mounted on the base element 10. The fixing member has a knob 18b, which makes it possible to pull the engagement pin 18a outwards by first turning the knob past a blocking position. The engagement pin 18a is spring-loaded in the direction inwards towards the tube 17, which, combined with the fact that the projecting pin 52 of the coupling member 50 has a bevelled lower end, allows snap-locking engagement between the engagement pin 18a and the groove 53. The engagement pin 18a projects in the mounted position in through the tube 17 and is in engagement with the circumferential groove 53 on the pin 52 of the first coupling member 50. The upper part 2b is thereby rotatably fixed to the lower part 2a.

In the mounted position, the upper part 2b is limitedly rotatable about a rotational axis defined by the pin 52, in relation to the lower part. A spring-back device 110 is disposed on the base element 10. The spring-back device 110 comprises two legs 111, each having an upper, forward projecting bead 112. The two legs 111 are mutually connected by means of an upper 113 and a lower 114 bridge and have at their lower end a screw hole 115 each. The spring-back device is fixed by means of the screw holes 115 and two transverse screws (not shown) to the base element 10, rotatably about a transverse rotational axis defined by the screws.

The upper end of the spring-back device 110 having the two beads 112 is pressed in the forward direction by a compression spring 117 (see FIG. 1b, 6a, 6b). The compression spring 117 is arranged around a screw 116, which is accommodated in threaded arrangement in a corresponding hole 119 provided in the base element. The screw extends through a hole which is made in the lower bridge 114. The compression spring 117 rests with its one end against the head of the screw 116 and with its other end against the lower bridge 114. The head of the screw has a grip-friendly knob for simple adjustment of the force with which the compression spring 117 presses the beads 112 in the forward direction.

When the upper part 2b of the backrest is mounted on the lower part 2a, the upper end of the spring-back device 110 projects with the two beads 112 into the lowermost built-on element 20 of the upper part. As can most clearly be seen from FIGS. 6a and 6b, the spring-loaded beads 112 interact with the front plate 22 of the built-on element 20 so as to return the upper part 2b to its normal position once the upper part has been rotated in relation to the lower part 2a. In the normal position, the slide plates 45 of the upper part 2b are parallel with the slide plate 12 of the base element. In this position, both beads 112 bear against the front plate 22 of the built-on element 20. Once the upper part 2b has been rotated in one direction about the rotational axis defined by the pin 52, the front plate 22, by bearing contact against that one of the two beads 112 which corresponds to the rotational direction, presses this bead, and hence the upper end of the spring-back device, in the rearward direction. The spring-back device then assumes the position shown in FIGS. 6a and 6b. In this position, the compression spring 117 endeavours to return the upper end of the spring-back device to the starting position. When the force applied by the user to rotate the upper part 2b from the normal position ceases, the spring-back device, by bearing contact of the corresponding one of the beads 112 against the front plate 22, returns the lower built-on element, and hence the whole of the upper part 2b, to the normal position.

The above-described facility to rotate the upper part 2b of the backrest in relation to the lower part 2a results in a substantially greater freedom of movement for the user compared to what was previously possible. The spring-back function additionally results in a relieving of load, which yields a considerable advantage, especially for disabled users.

The facility to easily separate the upper part 2b of the backrest from the lower part 2a also constitutes a substantial advantage. It is hence possible with a simple manoeuvre to remove the relatively bulky upper part 2b of the backrest and thereby substantially reduce the height of the wheelchair, for example when the wheelchair is transported in a vehicle. The fixing member is configured such that the engagement pin 18a, by turning of the knob 18b, can be locked in an extended position. Hence, the user can firstly, with one hand, release the engagement pin 18a and afterwards, with both hands, lift off the upper backrest part 2b from the lower one 2a. The configuration of the fixing member 18 also allows very simple remounting of the upper part 2b by virtue of the snap-locking function of the fixing member. The base element 10, and hence the lower part 2a of the backrest, has a height corresponding to the height of a user's lower back. With the upper part 2b removed, the wheelchair can, if so desired, be used when there is little need of support for the user's upper back and great need of freedom of movement.

Above, illustrative embodiments of the invention have been described. It will be appreciated, however, that the invention is not limited to this description, but rather that it can be freely varied within the scope of the following patent claims.

1. Backrest for a chair, for example a wheelchair, a vehicle chair, a office chair or the like, which backrest has a lower and an upper end, and a general longitudinal direction which extends between the lower and the upper end, wherein an upper part of the backrest is rotable about a rotational axis, which is essentially parallel with the longitudinal direction in relation to a lower part of the backrest, which lower part is prevented from rotation about said rotational axis.

2. Backrest according to claim 1, wherein the upper part is separable from the lower part.

3. Backrest according to claim 1, comprising a spring-back device, which is arranged to resiliently return the upper part to a normal position, when the upper part has been rotated, in relation to the lower part to a rotary position which is different from the normal position.

4. Backrest according to claim 3, wherein the spring-back device comprises a control device by means of which the force by which the spring-back device strives to return the upper part to the normal position may be adjusted.

5. Backrest according to any one of claim 1-4, wherein the lower part comprises a base element and the upper part a number of build-on elements which are releasably attachable to each other for allowing construction of a backrest having a variable length.

6. Backrest according to claim 5, comprising at least one with-adjusting member which is transversely displaceable fixed to at least one of the base element or the build-on elements, for allowing adjustment of the width of the backrest.

7. Chair comprising a backrest according claim 1.

8. Backrest for a wheelchair, which backrest has a lower and an upper end, and a general longitudinal direction which extends between the lower and the upper end, wherein at least one pair of width-adjusting members are fixed in a laterally displaceable manner to a central backrest framework extending in the longitudinal direction of the backrest, and wherein an extension member is displaceably fixed to at least one of the width-adjusting members, to allow adjustment of the width of the backrest.

9. Backrest according to claim 8, comprising a number of pairs of width-adjusting members disposed one after the other in the longitudinal direction and fixed to the backrest framework.

10. Backrest according to claim 8, wherein the pair of width-adjusting members comprises a first and a second width-adjusting plate, which are displaceable in the direction towards and away from each other along a common displacement axis.

11. Backrest according to claim 8, wherein the at least one extension member is formed of an elastic material and comprises an inner and an outer section, which outer section is more rigid than the inner section.

12. Backrest according to claim 8, comprising a number of elements arranged one after the other in the longitudinal direction, which elements make up the backrest framework and to which a pair of width-adjusting members is fixed.

13. Backrest according to claim 10, in which the width-adjusting plates comprise a first section (82a, 82b) and a second section, which second section extends in the direction diagonally outwards and forwards from the first section.

14. Backrest according to claim 12, wherein the elements are detachably fixed to one another to allow construction of backrests with variable length.

15. Backrest according to claim 12, wherein at least one of the elements is rotatable about a transverse rotational axis.

16. Wheelchair comprising a backrest according to claim 8.
